(19) United States
(12) Patent Application Publication
(10) Pub. No.: US 2014/0060335 A1
(43) Pub. Date: Mar. 6, 2014

(54) DEVICE FOR THE PREPARATION OF HOT WATER

(71) Applicant: Melitta Europa GmbH & Co.KG., Minden (DE)

(72) Inventor: Andreas Sachtleben, Minden (DE)

(73) Assignee: Melitta Europa GmbH & Co.KG., Minden (DE)

(21) Appl. No.: 14/016,885

(22) Filed: Sep. 3, 2013

(30) Foreign Application Priority Data
Sep. 3, 2012 (DE) 20 2012 103 353.4

(51) Int. Cl. A47J 31/56

(52) U.S. Cl. CPC A47J 31/56
USPC 99/281

(57) ABSTRACT

A device for the preparation of hot water includes a water reservoir, a tube system coupled to the water reservoir and a heating unit to heat the water passing through the tube system from the water reservoir. A float switch detects a water level in the water reservoir. The float switch includes a float arranged in the tube system to measure the water level in the water reservoir and a sensor responsive to the float to transmits a signal to an electronic component to activate the heating unit in dependence on the water level in the water reservoir.

### CROSS-REFERENCE TO RELATED APPLICATION

This application claims the priority of German Patent Application DE 20 2012 103 353.4, filed on Sep. 3, 2012, the subject matter of which is incorporated herein by reference in its entirety

### BACKGROUND OF THE INVENTION

The invention relates to a device for the preparation of hot water, in particular for use with an automatic coffee maker or tea maker, such a device comprising a water reservoir, a system of tubes for the water, a heating unit, and a sensor device for detecting a water level in the water reservoir.

Devices for heating up water are known. Thus, European patent document EP 1 442 688 B1 describes a water heating device provided with a switching to trigger a reaction in dependence on the amount of water inside a water holding chamber. For this, a sensor detects the amount of water and/or a minimum filling level in the water holding chamber. The sensor comprises a float device and is magnetically connected to the switch. If the water level in the holding chamber drops to a predetermined value, then the water heating devices in the water heating chamber are switched from a low capacity setting to a high capacity setting.

A device for the preparation of hot water is also known from the German patent document DE 20 2006 012 326 U1 and is used, in particular, for a coffee machine. In that case, the water is heated up only if water is withdrawn. A float is provided in this case to avoid an overheating of the heating system and to make sure that it is activated only if the water level is sufficiently high. The float operates jointly with a Reed switch which responds only if the container contains a sufficiently high amount of water.

European patent document EP 0 063 849 B1A discloses a float with a switch that is used for a coffee machine. A second water chamber with therein arranged float is installed below the water reservoir. If the water level in the water chamber drops to a minimum level, the electrical connection to a heating unit is interrupted to prevent overheating. However, this float design is very involved because of the separate water chamber installed below the water reservoir.

### SUMMARY OF THE INVENTION

It is an object of the present invention to develop a simple and cost-effective solution for detecting the water level in a device for the preparation of hot water, in particular used for an automatic coffee maker or tea maker.

The above and other objects are achieved according to an embodiment of the invention by a device for the preparation of hot water, comprising: a water reservoir; a tube system coupled to the water reservoir; a heating unit to heat the water passing through the tube system from the water reservoir; and a float switch for detecting a water level in the water reservoir, the float switch comprising a float arranged in the tube system to measure the water level in the water reservoir and a sensor responsive to the float to transmits a signal to an electronic component to activate the heating unit in dependence on the water level in the water reservoir.

The water level in the reservoir can thus be detected without having to integrate a detector into the water reservoir. By installing a float switch in the tube system, the overheating of the heating unit can nevertheless be prevented at a location that is separate from the water reservoir.

The float preferably comprises a magnet, the magnetic field of which is detected by the sensor. With the aid of this magnet, a switching operation can thus be triggered easily as a result of the float movement.

The float switch is provided for this with a float casing on which, or in which, the float is movably arranged, so that the float is guided in an upward or downward movement. A sensor for detecting a float position can be provided on the float casing.

### BRIEF DESCRIPTION OF THE DRAWINGS

These and other features and advantages of the invention will be further understood from the following detailed description of embodiments of the invention with reference to the accompanying drawings, which shown in:

FIG. 1—A sectional representation of a coffee machine with a float switch embodied according to the invention;

FIG. 2—A perspective representation of a float switch according to the invention;

FIG. 3—A vertical sectional representation of the float switch according to

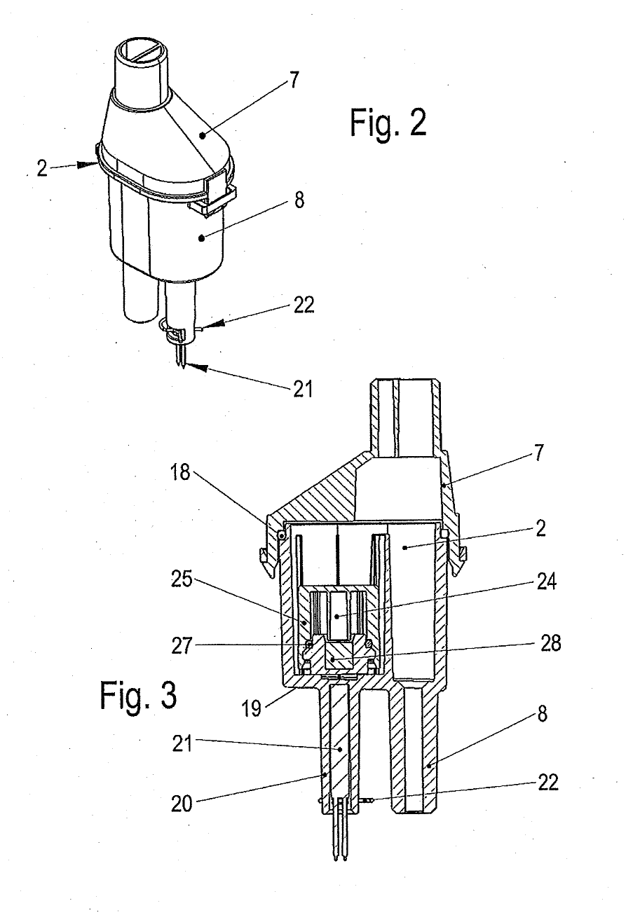

FIG. 2;

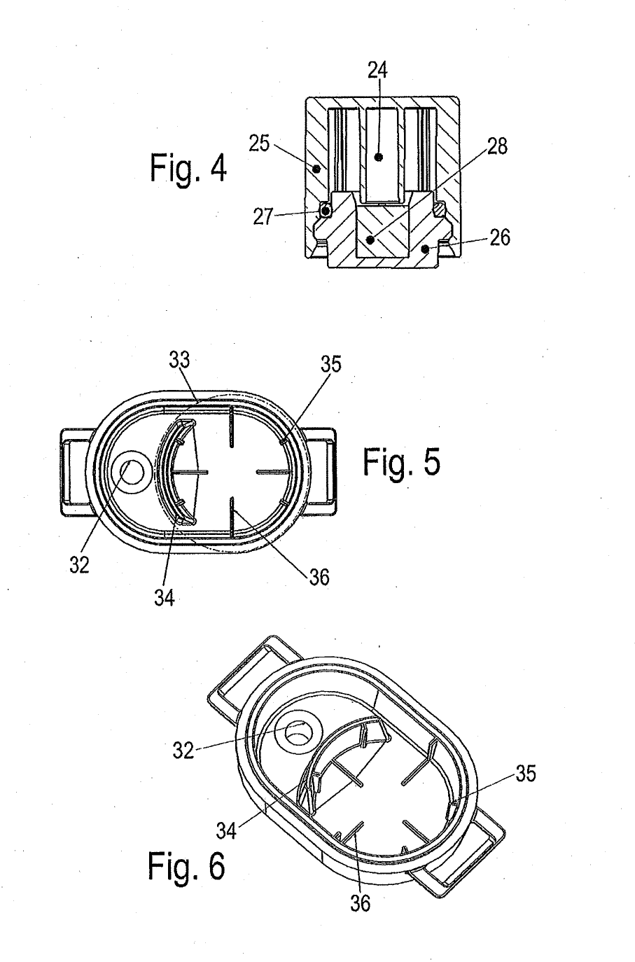

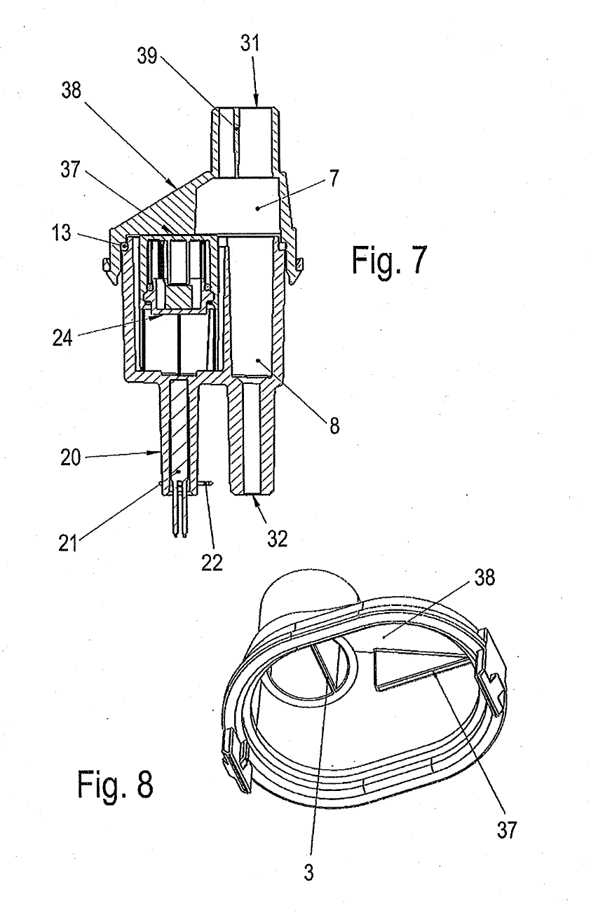

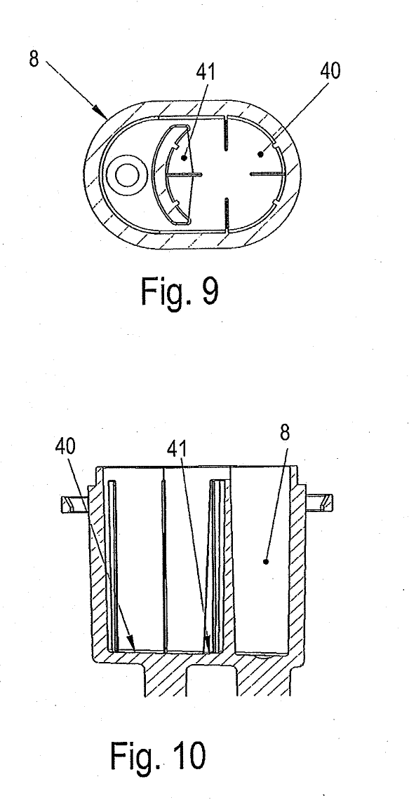

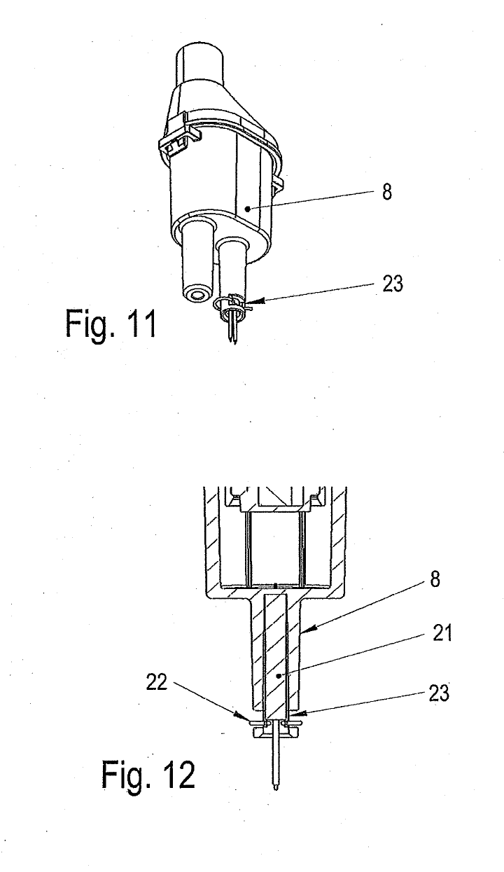

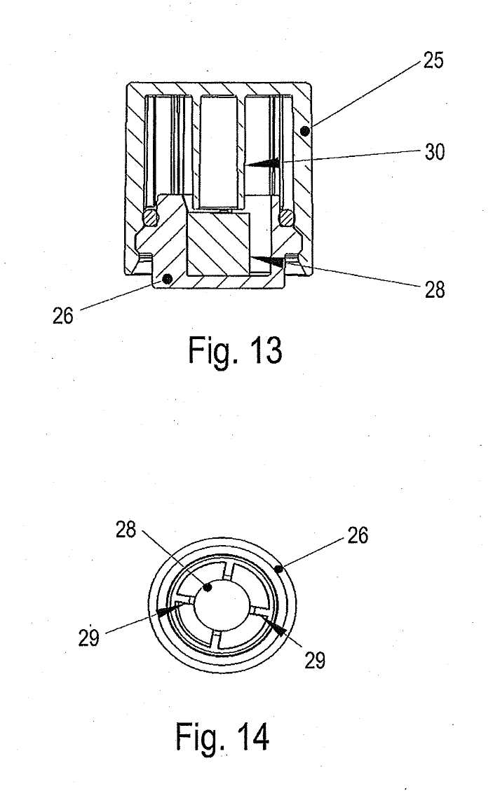

FIG. 4—A vertical sectional representation of the float from FIG. 3;

FIG. 5—A view from above of the lower part of a float casing;

FIG. 6—A perspective representation of the lower part of the float casing shown in FIG. 5;

FIG. 7—A second, vertical sectional representation through the float switch according to FIG. 3;

FIG. 8—A perspective representation of an upper part of the float casing;

FIG. 9—A second horizontal sectional representation of the lower part of the float casing according to FIG. 5;

FIG. 10—A vertical sectional representation of the lower part of the float casing according to FIG. 5;

FIG. 11—A perspective representation of the lower part of the float casing;

FIG. 12—A detail from a vertical sectional representation of the lower part of the float casing;

FIG. 13—A sectional representation of a float body;

FIG. 14—A perspective representation of a float bottom provided with a magnet.

### DETAILED DESCRIPTION

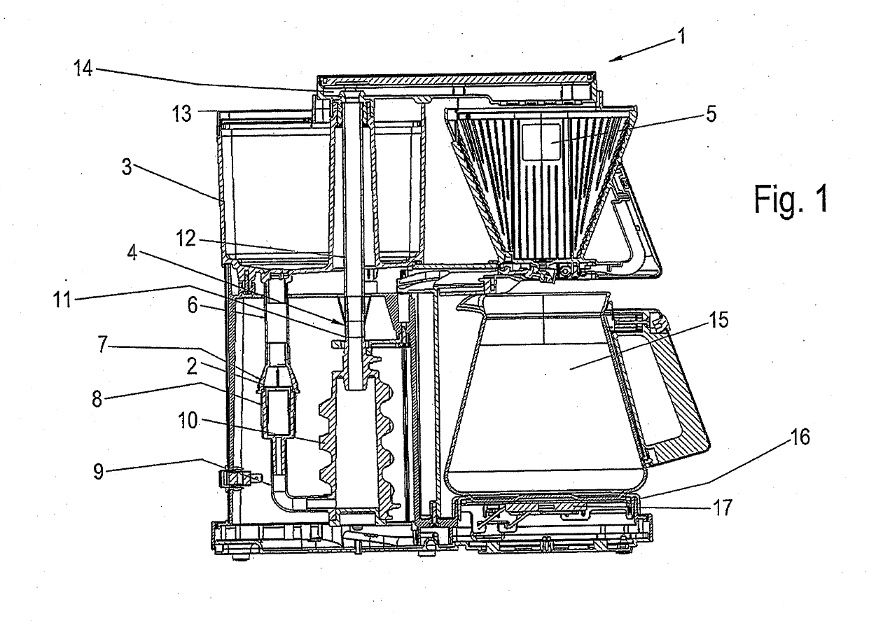

Referring to FIG. 1, there is shown a coffee machine 1 provided with a float switch 2 according to an embodiment of the invention. The coffee machine 1 comprises a water reservoir 3 into which the desired amount of water is filled for the preparation of coffee. A tube and/or hose system 4 adjoins the water reservoir 3 and functions to supply water to a filter holder 5.

The tube segment 6 which starts directly at the water reservoir 3 is connected to a float switch 2 according to the invention. The float switch 2 comprises an upper float casing part 7 and a lower float casing part 8.

The lower casing part 8 for the float is connected via an angled tube 9 to a heating unit 10. A vertical tube 12 adjoins the heating unit 10 via a hose connection 11. A seal 13 connects the vertical tube 12 to an overflow 14 which functions to conduct the water heated with the heating unit 10 into the filter body 5.

Once it passes through a filter bag in the filter holder 5, the liquid then flows into a glass carafe 15. The glass carafe 15 rests on a warming plate 16 which is heated by an additional heating unit 17.

It follows from FIG. 1 that the float switch 2 is arranged below the water reservoir 3, within the tube system 4, and does not determine the geometry of the water reservoir 3. The water reservoir can thus be cleaned easily since there is no interference from a detection device for determining the water level. Owing to the integration of the float switch 2 in the tube system, a simple and cost-effective design is created.

The float switch 2 is shown in further detail in FIGS. 2 and 3. A seal 8 is inserted between the upper casing part 7 and the lower casing part 8. Seal 8 is designed to seal the two casing parts, which are snapped together, against each other.

A sensor 21 is installed in a tubular extension 20 that adjoins the underside 19 of the lower float casing part 8. The sensor 21 is secured easily with the aid of an elastic clamp or spring 22 to prevent it from sliding out of the tubular extension 20.

FIGS. 11 and 12 show that the tubular extension 20 is provided with grooves or recesses 23 for inserting the elastic clamp 22. The sensor 21 can thus be installed easily and can then be secured permanently in the installed position.

A float 24 is located in the lower float casing part 8. The float 24 illustrated in FIG. 4 consists of a float body 25 and a float bottom 26. These two components are joined with the aid of a cylindrical locking connection and are protected against penetrating water with the aid of an O ring 27.

A magnet 28 is arranged in the float bottom 26. As shown in FIG. 14, this magnet 28 can be inserted easily into a holding space formed by ribs 29 that are arranged in a cross-shaped pattern.

To ensure a secure function of the float switch 2, the position of the magnet 28 cannot change. However, the snap-in connection between the float body 25 and the float bottom 26 is sufficient to lock in place the magnet 28. Once this locking connection is established, a spacer 30 that is formed onto an upper inside of the float body 25 is located at a very short distance to the magnet 28, so that when the magnet 28 shifts it hits the spacer 30, thus preventing a displacement of the magnet 28 in the float bottom 26 which would interrupt the function.

A shown in FIGS. 5 and 7, the water-carrying part of the float switch 2 consists of a supply tube 31, a drain tube 32, and a float guiding region 33 which is embodied similar to a bypass.

The float guiding region 33 is formed by a casing wall of the lower float casing part 8 and a wall segment 34 that is embodied circular cylindrical. For this, the casing wall and the circular-cylindrical wall segment 34 are provided with narrow, vertically extending wall ribs 35.

The bottom region of the float guiding region 33 preferably contains four narrow, horizontally extending bottom ribs 36. These bottom ribs 36 form the support surface for the float 24. As a result, it is possible to embody the contact surface of the float 24 with the lower float casing part 8 with minimum dimensions. In this way, possible adhesion forces between the float 24 and the lower float casing part 8 can be minimized to ensure an uninterrupted upward movement of the float 24.

The bottom ribs 36 and the wall segment 34 are provided with chamfered surfaces for the unmolding during the production process.

FIG. 3 shows the situation where the water reservoir 3 and the float switch 2 do not contain water. In that case, the distance is at a minimum between the magnet 28 and the sensor 21 which reacts to the magnetic field of the magnet 28. In this position, the sensor 21 transmits a corresponding signal to an electronic component, not shown herein, of the heating unit 10. The electronic component in that case prevents current from flowing through the heating unit 10, thus also preventing an overheating of the device if it no longer contains any water.

If water is filled once more into the water reservoir 3, the water is distributed throughout the tube system 4 of the coffee machine 1, on the basis of the principle of communicating tubes. In that case, the float switch 2 is also filled with water. The float 24 is designed such that its total density is less than that of the water, thus resulting in buoyancy for the float 24 which then moves toward the top in the lower float casing part 8.

In FIG. 7, the float 24 is shown in this upper position. The buoyancy of the float 24 is limited by a stop face in the form of a rib 37 that is integrated into the upper float casing part 7. As a result, the float 24 can only move in the float guiding region 33 and cannot tilt while in the upper position.

For a secure function, the buoyancy of the float 24 should not be interfered with by frictional forces caused by contact with the wall of the lower float casing part 8. This is ensured by the arrangement and the embodiment of the narrow vertical wall ribs 35, wherein other types of guide mechanisms can also be provided.

During the filling of water into the coffee machine 1, the air in the water-carrying part of the device must be allowed to escape. To make it easier for the air in the float switch 2 to escape, one wall region 38 of the upper float casing part 7 is embodied cone-shaped above the float guiding region 33. This cone-shaped wall region 38 ensures that during the filling in of water and the associated upward movement of the float 24, the air in the float switch 2 can escape easily toward the top.

The supply tube 31 is additionally connected to a separating rib 39 to ensure an easier discharge of the air. As a result, the air rising along the cone-shaped wall region 38 can rise toward the top along one side of the separating rib 39 while the inflowing water can flow in unhindered on the other side of the separating rib 39.

If no more water is added, then the water finally also flows out of the float switch 2. To prevent residual water from remaining inside the float switch 2, the bottom of the lower part 8 of the float casing is provided with a slanted drain surface 40. The corresponding bottom region 41 is also embodied slanted in the drainage direction for the water, so that the water can drain out in the region of the circular cylindrical wall segment 34. As a result, it is ensured that residual water in the float switch 2 can always drain securely in the direction of the drainage tube 32, thereby avoiding micro-biological problems caused by residual moisture.

It will be understood that the above description of the present invention is susceptible to various modifications, changes and adaptations, and the same are intended to be comprehended within the meaning and range of equivalents of the appended claims

What is claimed is:

1. A device for the preparation of hot water, comprising:
a water reservoir;
a tube system coupled to the water reservoir;
a heating unit to heat the water passing through the tube system from the water reservoir; and
a float switch for detecting a water level in the water reservoir, the float switch comprising a float arranged in the tube system to measure the water level in the water reservoir and a sensor responsive to the float to transmits a signal to an electronic component to activate the heating unit in dependence on the water level in the water reservoir.

2. The device according to claim 1, wherein the float includes a magnet having a magnetic field for detection by the sensor.

3. The device according to claim 1, wherein the float switch comprises a float casing in which the float is arranged.

4. The device according to claim 3, wherein the float casing comprises an upper casing part and a lower casing part for the float.

5. The device according to claim 4, further including a seal arranged between the upper float casing part and the lower float casing part to form a water-tight connection between the lower casing part and the upper casing part.

6. The device according to claim 1, wherein the float casing has a tubular extension, and the sensor is arranged in a tubular extension and is secured with an elastic clamp.

7. The device according to claim 1, wherein the float comprises a float body and a float bottom.

8. The device according to claim 7, wherein float bottom has a space for accommodating the magnet.

9. The device according to claim 7, wherein the float body comprises a spacer to securely position the magnet.

10. The device according to claim 3, wherein the lower float casing part has a bottom region with ribs which form a support surface for the float.

11. The device according to claim 3, wherein the lower float casing part includes an inside surface and wall ribs formed on the inside surface.

12. The device according to claim 3, wherein the upper float casing part has a top and a cone-shaped wall region that is tapered toward the top.

13. The device according to claim 12, wherein the cone-shaped wall region has an inside and includes a stop face for the float on the inside of the cone-shaped wall region.

14. The device according to claim 3, wherein the upper float casing part comprises a feed tube having a separating rib that allows air to escape while the water is filled in.

15. The device according to claim 1, wherein the float switch is arranged below the water reservoir.
